(19) United States
(12) Patent Application Publication
(10) Pub. No.: US 2025/0137936 A1
(43) Pub. Date: May 1, 2025

(54) STRUCTURE EXTERIOR INSPECTION SYSTEM AND STRUCTURE EXTERIOR INSPECTION METHOD USING THE SAME

(71) Applicants: banseok CO., LTD., Namyangju-si (KR); Smart Technology Construction Co., Ltd, Jeollanam-do (KR); Infrastructure safety Co., Ltd., Seoul (KR)

(72) Inventor: JONGBIN WON, Seoul (KR)

(73) Assignees: banseok CO., LTD., Namyangju-si (KR); Smart Technology Construction Co., Ltd, Jeollanam-do (KR); Infrastructure safety Co., Ltd., Seoul (KR)

(21) Appl. No.: 18/926,263

(22) Filed: Oct. 24, 2024

(30) Foreign Application Priority Data
Oct. 27, 2023 (KR) 10-2023-0145176

(51) Int. Cl. G01N 21/88; G01B 11/26; G01S 17/42; G01S 17/86; G06T 7/00

(52) U.S. Cl. CPC G01N 21/8806; G01B 11/26; G01S 17/42; G01S 17/86; G06T 7/0002

(57) ABSTRACT

A structure exterior inspection system according to the present invention includes an image capturing unit including an imaging unit that captures an exterior image of a structure and a laser rangefinder that irradiates 3-point or more laser to a surface of the structure within a field of view of the imaging unit, an angle estimation module estimating an angle of the imaging unit with respect to a plane of the structure appearing in the image captured by the imaging unit, a quantification module quantifying a damaged area of the structure appearing in the image captured by the imaging unit, and a damage reading module reading a damage status of the structure appearing in the image captured by the imaging unit.

### CROSS-REFERENCE TO RELATED APPLICATION

This application claims priority under 35 U.S.C. § 119 (a) to Korean Patent Application No. 10-2023-0145176, filed on Oct. 27, 2023, in the Korean Intellectual Property Office, the disclosure of which is incorporated herein by reference in its entirety.

### BACKGROUND

### (a) Technical Field

The present invention relates to a structure exterior inspection system and a structure exterior inspection method using the same, and more particularly, to a structure exterior inspection system capable of determining a condition of a structure in an efficient and reliable manner, and a structure exterior inspection method using the same.

### (b) Background Art

Safety inspection of facilities is a procedure regularly performed to ensure the safety and maintenance of functions of public and private facilities so that it discovers physical and functional defects in facilities and takes appropriate action.

Generally, construction specifications should be stipulated to inspect the exterior through such safety inspection, create the inspection results by an external inspection network diagram, and manage the history.

Among them, the exterior inspection of the facilities is a safety inspection method that can detect physical and functional defects of facilities at an early stage, such as structural damage, cracks, corrosion, damage, leaks, poor joints, and maintenance status of fire safety facilities.

The exterior inspection of the facilities is performed through procedures such as on-site inspection, damage quantification, field/photographic recording, manual damage interpretation, video alignment, drawing conversion, and exterior inspection network diagram creation.

However, the conventional capturing equipment used for the facility exterior inspection procedure has a disadvantage in that it cannot quantify damage to facilities because it does not know a capturing distance and angle information.

For example, assuming that a crack of 220 mm in length exists, the conventional capturing equipment will have an estimation error of up to 30 mm when the capturing angle is changed by 30°, making it difficult to quantify damage.

In addition, since the conventional capturing equipment has many parts that are difficult for the equipment to access, a manpower-centered exterior inspection should be essentially performed, which also has the disadvantage of requiring a lot of manpower and cost.

In addition, since the subjective determination of workers is bound to be involved, there is a problem that the consistency of the results is low.

Therefore, a method for solving these problems is required.

### PRIOR ART DOCUMENT

### Patent Document

Korean Patent No. 10-2260559

### SUMMARY OF THE INVENTION

The present invention is devised to solve the problems of the prior art described above, and its object is to provide a structure exterior inspection system capable of quantifying damage by capturing an exterior of a structure and automatically correcting the exterior, and an efficient structure exterior inspection method using the same.

The problems of the present invention are not limited to the above problems, and other problems that are not mentioned may be obviously understood by those skilled in the art from the following specification.

According to an aspect of the present invention, there is provided a structure exterior inspection system including: an image capturing unit including an imaging unit that captures an exterior image of a structure and a laser rangefinder that irradiates a 3-point or more laser to a surface of the structure within a field of view of the imaging unit; an angle estimation module estimating an angle of the imaging unit with respect to a plane of the structure appearing in the image captured by the imaging unit; a quantification module quantifying a damaged area of the structure appearing in the image captured by the imaging unit; and a damage reading module reading a damage status of the structure appearing in the image captured by the imaging unit.

In this case, the laser rangefinder may be arranged to maintain a uniform relative position with respect to the imaging unit.

For example, the laser rangefinder may be formed in a form that it is mounted on the imaging unit.

In addition, the laser rangefinder may include a body including a connecting part arranged to be mounted on the imaging unit, 3 or more laser oscillation units mounted on the body and irradiating laser, and a distance calculation unit calculating a distance from a laser irradiation point of the laser oscillation unit to the structure.

In addition, the angle estimation module may include: a vector generation unit generating a normal vector with respect to the plane of the structure positioned in an optical axis direction of the imaging unit; a virtual coordinate generation unit generating coordinates for 3-point or more laser irradiation points and virtual coordinates for the 3-point or more laser irradiated onto the plane of the structure through the normal vector with respect to the plane of the structure generated by the vector generation unit; a distance estimation unit deriving an estimated distance from the 3-point or more laser irradiation points to the structure through the virtual coordinates generated by the virtual coordinate generation unit; and an angle estimation unit estimating an angle of the imaging unit with respect to the structure through the virtual coordinates generated by the virtual coordinate generation unit and the estimated distance derived by the distance estimation unit.

In addition, the quantification module may include: a scale estimation unit estimating a scale factor for converting a damaged area of the structure appearing in the image captured by the imaging unit into an actual size, a focal length estimation unit estimating an effective focal length of the imaging unit; and a quantification unit quantifying a shape of the damaged area of the structure appearing in the image captured by the imaging unit through the scale factor estimated by the scale estimation unit and the effective focal length estimated by the focal length estimation unit.

In addition, the damage reading module may include: a labeling processing unit labeling a type of damage of the structure appearing in the image; an annotation processing unit extracting and displaying the damaged area of the structure appearing in the image; and a format conversion unit converting the shape of the damaged area displayed by the annotation processing unit into another format available on preset software.

According to another aspect of the present invention, there is provided a structure exterior inspection method including the steps of: (a) irradiating a surface of a structure with a 3-point or more laser through a laser rangefinder; (b) capturing an exterior image of the structure through an imaging unit; (c) estimating, by an angle estimation module, an angle of the imaging unit with respect to a plane of the structure appearing in the image captured by the imaging unit to correct an error; (d) quantifying, by a quantification module, a damaged area of the structure appearing in the image captured by the imaging unit; and (e) reading, by a damage reading module, a damage status of the structure appearing in the image captured by the imaging unit.

In this case, the laser rangefinder may be arranged to maintain a uniform relative position with respect to the imaging unit, and the steps (a) and (b) may be performed multiple times by varying a distance between the imaging unit and the laser rangefinder and the structure to acquire a plurality of images.

In addition, the step (c) may include: (c-1) generating, by a vector generation unit of the angle estimation module, a normal vector with respect to the plane of the structure positioned in an optical axis direction of the imaging unit; (c-2) generating, by a virtual coordinate generation unit of the angle estimation module, coordinates for 3-point or more laser irradiation points and virtual coordinates for the 3-point or more laser irradiated onto the plane of the structure through the normal vector with respect to the plane of the structure generated by the vector generation unit; (c-3) deriving, by a distance estimation unit of the angle estimation module, an estimated distance from the 3-point or more laser irradiation points to the structure through the virtual coordinates generated by the virtual coordinate generation unit; and (c-4) estimating, by an angle estimation unit of the angle estimation module, an angle of the imaging unit with respect to the structure through the virtual coordinates generated by the virtual coordinate generation unit and the estimated distance derived by the distance estimation unit.

Meanwhile, the structure exterior inspection method may further include the step of: prior to the step (c), (ex) measuring an error degree for the 3-point or more laser irradiated by the laser rangefinder, in which the step (c) may be performed by reflecting the error degree measured in the step (ex).

Here, the step (ex) may include the steps of: (ex-1) positioning a target in front of a slide unit provided such that the mounting target is movable back and forth along a straight track; (ex-2) mounting the laser rangefinder and the imaging unit provided so as to maintain a uniform relative position to each other on the slide unit; (ex-3) irradiating the 3-point or more laser onto the target through the laser rangefinder, moving the laser rangefinder and the imaging unit in the target direction through the slide unit, and acquiring the 3-point or more laser irradiation points for each of the plurality of points; and (ex-4) estimating an irradiation angle of the 3-point or more laser through a change in position for each of the 3-point or more laser irradiation points acquired in the step (ex-3) and a movement distance of the laser rangefinder and the imaging unit.

In addition, the step (d) may include the steps of: (d-1) estimating, by a scale estimation unit of the quantification module, a scale factor for converting a damaged area of the structure appearing in the image captured by the imaging unit into an actual size; (d-2) estimating, by a focal length estimation unit of the quantification module, an effective focal length of the imaging unit; and (d-3) quantifying, by a quantification unit of the quantification module, a shape of the damaged area of the structure appearing in the image captured by the imaging unit through the scale factor estimated by the scale estimation unit and the effective focal length estimated by the focal length estimation unit.

In addition, the step (e) may include the steps of: (e-1) labeling, by a labeling processing unit of the damage reading module, a type of damage to the structure appearing in the image; (e-2) extracting and displaying, by an annotation processing unit of the damage reading module, the damaged area of the structure appearing in the image; and (e-3) converting, by a format conversion unit of the damage reading module, a shape of the damaged area displayed by the annotation processing unit into another format available on preset software.

To solve the above-descried problems, according to the structure exterior inspection system and the structure exterior inspection method using the same of the present invention, by acquiring the image using the imaging unit that captures the exterior image of the structure and the laser rangefinder that irradiates the 3-point or more laser to the surface of the structure within the field of view of the imaging unit and estimating the capturing angle and capturing distance of the image by the angle estimation module, it is possible to accurately identify the damage status of the structure even at any angle and distance.

In addition, according to the present invention, it is possible to easily quantify the damaged areas of the structure by the quantification module, label the type of damage of the structure appearing in the image by the damage reading module, extract and display the damaged areas and then automatically convert the damaged areas into other formats that can be used in other software, and easily assist various post-processing tasks.

In addition, according to the present invention, it is possible to manage various types of data generated during the external investigation process, such as images, types of damage, capturing dates, and structure names, by managing various types of data into a database, and build a growth platform through the continuous strengthening of the system.

The effects of the present invention are not limited to the aforementioned effects, and other effects that are not mentioned may be obviously understood by those skilled in the art from the claims.

### BRIEF DESCRIPTION OF THE DRAWINGS

FIG. 1 is a diagram schematically illustrating components that constitute a structure exterior inspection system according to an embodiment of the present invention.

FIG. 2 is a diagram illustrating the entire process of the structure exterior inspection method according to an embodiment of the present invention.

FIG. 3 is a diagram illustrating a detailed process of step (ex) in a structure exterior inspection method according to an embodiment of the present invention.

FIG. 4 is a diagram conceptually illustrating an appearance of performing step (ex) in the structure exterior inspection method according to an embodiment of the present invention.

FIG. 5 is a diagram illustrating a detailed process of step (c) in the structure exterior inspection method according to an embodiment of the present invention.

FIG. 6 is a diagram for conceptually describing a process of performing step (c) in the structure exterior inspection method according to an embodiment of the present invention.

FIG. 7 is a diagram illustrating a detailed process of step (d) in the structure exterior inspection method according to an embodiment of the present invention.

FIG. 8 is a diagram for conceptually describing a detailed process of performing step (d) in the structure exterior inspection method according to an embodiment of the present invention.

FIG. 9 is a diagram illustrating a detailed process of step (e) in the structure exterior inspection method according to an embodiment of the present invention.

FIGS. 10 to 14 are diagrams exemplarily illustrating an interface of software provided to perform step (e) in the structure exterior inspection method according to one embodiment of the present invention.

### DETAILED DESCRIPTION

In this specification, when a component (or area, layer, part, etc.) is referred to as “being on,” “connected to,” or “coupled to” another component, it means that the component may be arranged/connected/coupled directly on another component or a third component may also be arranged therebetween.

Like reference numerals refer to like elements. In addition, in the drawings, the thicknesses, rates, and dimensions of components are exaggerated for efficient description of technical contents.

“And/or” includes all combinations of one or more that the associated configurations may define.

The terms such as ‘first’ and ‘second’ may be used to describe various components, but these components are not to be interpreted to be limited to these terms. The terms are used only to distinguish one component from another component. For example, the first component may be named the second component and the second component may also be similarly named the first component, without departing from the scope of the present invention. Singular forms include plural forms unless the context clearly indicates otherwise.

In addition, the terms such as “below,” “on lower side,” “above,” and “on upper side” are used to describe the relationship between components illustrated in the drawings. The above terms are relative concepts and are described based on a direction indicated in the drawings.

Unless defined otherwise, all terms (including technical and scientific terms) used herein have the same meaning as generally understood by those skilled in the art to which the present invention belongs. In addition, the terms such as those defined in commonly used dictionaries should be construed as having meanings consistent with their meanings in the context of the relevant technology, and unless interpreted in an idealized or overly formal meaning, are explicitly defined herein.

It should be further understood that term “include” or “have” specifies the presence of features, numerals, steps, operations, components, parts mentioned in the present specification, or combinations thereof, but do not preclude the presence or addition of one or more other features, numerals, steps, operations, components, parts, or combinations thereof.

In addition, in this specification, when it is mentioned that a first component is operated or executed on a second component (ON), the first component should be understood as operating or being executed in an environment in which the second component operates or is executed, or operating or being executed through direct or indirect interaction with the second component.

When any component, device, or system is stated as including components composed of programs or software, even if not explicitly stated, the component, device, or system should be understood as including any hardware (e.g., memory, CPU, etc.) or other programs or software (e.g., driver or the like needed to run the operating system or hardware) necessary for the programs or software to run or operate.

In addition, unless otherwise specified in the implementation of a component, it should be understood that any component may be implemented in any form of software, hardware, or both software and hardware.

In addition, the terms used in the present specification are for describing exemplary embodiments rather than limiting the present invention. Unless explicitly described to the contrary, a singular form includes a plural form in the present specification. Throughout this specification, the terms “comprises” and/or “comprising” will be understood to imply the inclusion of stated constituents but not the exclusion of any other constituents.

In addition, in this specification, the terms such as “unit” and “device” may be intended to refer to the functional and structural combination of hardware and software driven by or for driving the hardware. For example, the hardware here may be a data processing device including a CPU or other processor. In addition, software driven by hardware may refer to a running process, object, executable file, thread of execution, program, etc.

In addition, the above terms may mean a predetermined code and a logical unit of hardware resources for executing and the predetermined code, and it can be easily inferred by an average expert in the technical field of the present invention that the above terms do not necessarily mean a physically connected code or a single type of hardware.

Hereinafter, specific technical details to be implemented in the present invention will be described in detail with reference to the accompanying drawings.

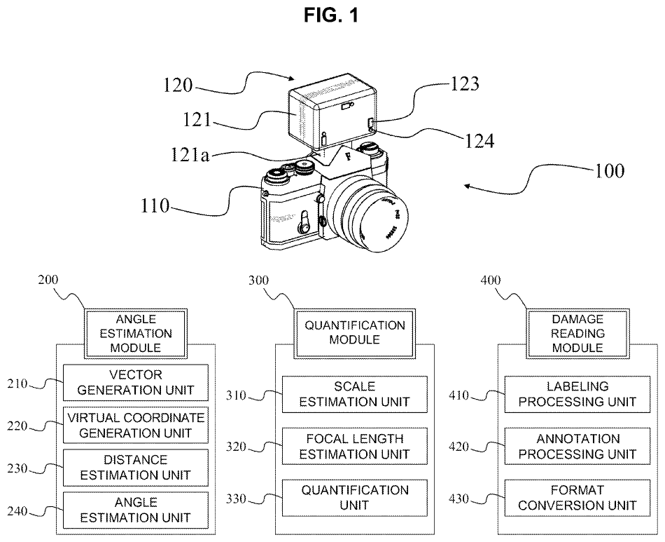

FIG. 1 is a diagram schematically illustrating components that constitute a structure exterior inspection system according to an embodiment of the present invention.

As illustrated in FIG. 1, a structure exterior inspection system according to an embodiment of the present invention includes an image capturing unit 100, an angle estimation module 200, a quantification module 300, and a damage reading module 400.

The image capturing unit 100 includes an imaging unit 110 that captures an exterior image of a structure, and a laser rangefinder 120 that irradiates a 3-point or more laser to a surface of the structure within a field of view of the imaging unit 110.

In the present embodiment, the imaging unit 110 is a camera including an image sensor, but any device capable of acquiring an exterior image of the structure may be applied as the imaging unit 110.

The laser rangefinder 120 is provided to irradiate the 3-point or more laser to the surface of the structure within a field of view of an image that can be acquired through the imaging unit 110. In other words, the laser rangefinder 120 may be in the form of irradiating a laser of 3 points or in the form of irradiating the 3-point or more laser.

The laser rangefinder 120 may be arranged to maintain a uniform relative position with respect to the imaging unit 110.

In the present embodiment, the laser rangefinder 120 is formed to maintain a uniform relative position with respect to the imaging unit 110 by being directly mounted on the imaging unit 110. However, the laser rangefinder 120 does not necessarily have to be directly mounted on the imaging unit 110, and may be installed at any position as long as it may maintain the uniform relative position with respect to the imaging unit 110.

More specifically, in the present embodiment, the laser rangefinder 120 includes a body 121, a laser oscillation unit 122, and a distance calculation unit 123.

The body 121 includes a connection part 121a that is arranged to be mounted on the imaging unit 110.

The laser oscillation unit 122 is arranged to irradiate a laser, and three or more laser oscillation units 122 are mounted on the body 121.

The distance calculation unit 123 is provided to calculate a distance from a laser irradiation point of the laser oscillation unit 122 to the structure.

According to this configuration, the laser rangefinder 120 may estimate an angle of the imaging unit 110 through three or more lasers.

In particular, when the imaging unit 110 is a commercial camera, the connection part 121a of the laser rangefinder 120 is formed in a jig shape that can be connected to a hot shoe of the imaging unit 110, and thus, may be directly connected to the imaging unit 110.

In addition, the imaging unit 110 and the laser rangefinder 120 may also be automatically controlled by a separate terminal through wireless or wired communication, and the imaging unit 110 and the laser rangefinder 120 each have a built-in display so that an operator may monitor a capturing process.

The angle estimation module 200 is provided to estimate the angle of the imaging unit 110 with respect to the plane of the structure that appears in the image captured by the imaging unit 110.

In the present embodiment, the angle estimation module 200 may include in detail a vector generation unit 210, a virtual coordinate generation unit 220, a distance estimation unit 230, and an angle estimation unit 240.

The vector generation unit 210 performs the role of generating a normal vector with respect to the plane of the structure positioned in an optical axis direction of the imaging unit 110.

The virtual coordinate generation unit 220 performs the role of generating coordinates for 3-point or more laser irradiation points and virtual coordinates for the 3-point or more laser irradiated to the plane of the structure through the normal vector with respect to the plane of the structure generated by the vector generation unit.

The distance estimation unit 230 derives an estimated distance from the 3-point or more laser irradiation points to the structure through the virtual coordinates generated by the virtual coordinate generation unit 220.

The angle estimation unit 240 estimates the angle of the imaging unit 110 with respect to the structure through the virtual coordinates generated by the virtual coordinate generation unit 220 and the estimated distance derived by the distance estimation unit 230.

The process of estimating the angle of the imaging unit 110 through the detailed configuration of the angle estimation module 200 will be described in more detail later.

The quantification module 300 is provided to quantify the damaged area of the structure appearing in the image captured by the imaging unit 110.

In the present embodiment, the quantification module 300 may include in detail a scale estimation unit 310, a focal length estimation unit 320, and a quantification unit 330.

The scale estimation unit 310 is a component that estimates a scale factor for converting the damaged area of the structure appearing in the image captured by the imaging unit 110 into an actual size.

The focal length estimation unit 320 performs the role of estimating the effective focal length of the imaging unit 110.

The quantification unit 330 is a component that quantifies the damaged area shape of the structure appearing in the image captured by the imaging unit 110 through the scale factor estimated by the scale estimation unit 310 and the effective focal length estimated by the focal length estimation unit 320.

The process of quantifying the damaged area shape of the structure through the detailed configuration of the quantification module 300 will also be described later.

The damage reading module 400 is provided to read the damage status of the structure appearing in the image captured by the imaging unit 110.

In the present embodiment, the damage reading module 400 may include in detail a labeling processing unit 410, an annotation processing unit 420, and a format conversion unit 430.

The labeling processing unit 410 is configured to label the type of damages of the structure appearing in the image.

The annotation processing unit 420 is configured to extract and display the damaged area of the structure appearing in the image.

The format conversion unit 430 performs the role of converting the form of the damaged area displayed by the annotation processing unit 420 into another format that is available on preset software.

The process of extracting and processing the damaged area of the structure through the detailed configuration of the damage reading module 400 will be described later.

Meanwhile, each configuration of the angle estimation module 200, the quantification module 300, and the damage reading module 400, illustrated in FIG. 1 may be functionally and logically separated. In addition, an average expert in the technical field of the present invention may easily infer that each configuration is not necessarily separated into a separate physical device or written in a separate code. Hereinafter, the process of performing a structure exterior inspection through the structure exterior inspection system as described above will be described in detail.

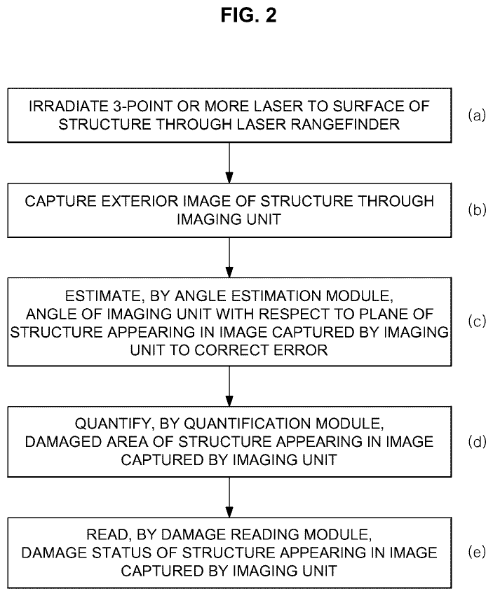

FIG. 2 is a diagram illustrating the entire process of the structure exterior inspection method according to an embodiment of the present invention.

As illustrated in FIG. 2, the structure exterior inspection method according to one embodiment of the present invention may include steps (a) to (e).

Step (a) is the process of irradiating the surface of the structure with the 3-point or more laser through the laser rangefinder 120, and step (b) is the process of capturing the exterior image of the structure through the imaging unit 110.

In other words, steps (a) and (b) are the processes of acquiring the exterior image of the structure, and as described above, the laser rangefinder 120 may be arranged to maintain a uniform relative position with respect to the imaging unit 110. In this case, steps (a) and (b) may be performed multiple times by varying the distance between the imaging unit 110 and the laser rangefinder 120 and the structure to acquire a plurality of images.

In addition, since the image acquired through the imaging unit 110 forms a predetermined angle with respect to the surface of the structure, a process of estimating the angle of the imaging unit 110 with respect to the plane of the structure in the image to correct an error is essentially required.

Therefore, in step (c), the process of estimating, by the angle estimation module 200, the angle of the imaging unit 110 with respect to the plane of the structure that appears in the image captured by the imaging unit 110 to correct the error is performed.

Meanwhile, in the case of the present embodiment, prior to step (c), step (ex) of measuring the error degree for the 3-point or more laser irradiated by the laser rangefinder 120 may be further included.

Step (ex) is a preliminary task for step (c), and is a process for correcting a manufacturing error for the 3-point or more laser irradiated by the laser rangefinder 120 and an angle error that occurs when the laser rangefinder 120 is mounted on the imaging unit 110.

That is, step (c) may be performed by reflecting the error degree measured in step (ex), and therefore, step (ex) will be described before step (c).

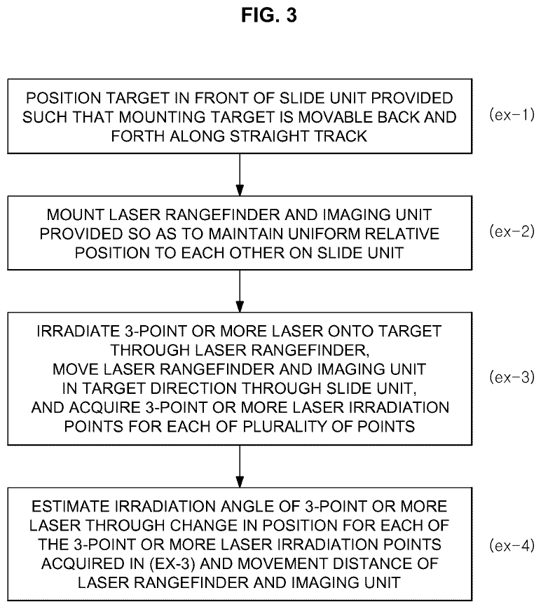

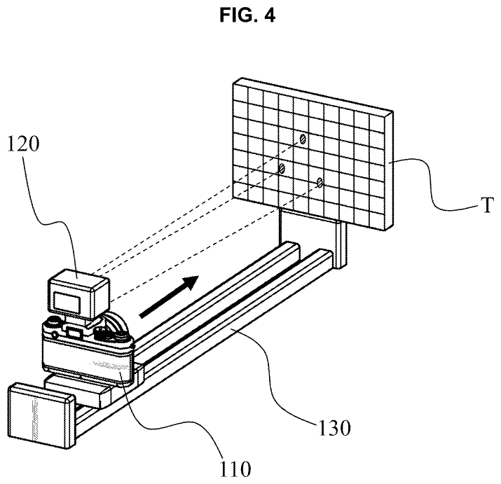

FIG. 3 is a diagram illustrating a detailed process of step (ex) in the structure exterior inspection method according to an embodiment of the present invention, and FIG. 4 is a diagram conceptually illustrating an example of performing step (ex) in the structure exterior inspection method according to an embodiment of the present invention.

As illustrated in FIG. 3 and FIG. 4, step (ex) in the present embodiment may include steps (ex-1) to (ex-4) in detail.

Step (ex-1) is a process of positioning a target T in front of a slide unit 130 provided so that the mounting target can move back and forth along a straight track.

For example, the target T may be a grid paper on which the 3-point or more laser irradiation points may be marked.

Step (ex-2) is a process of mounting the laser rangefinder 120 and the imaging unit 110 that are provided so as to maintain a uniform relative position to each other on the slide unit 130. As described above, in the present embodiment, the laser rangefinder 120 has a form that it is mounted on a hot shoe part of the imaging unit 110.

Step (ex-3) is a process of irradiating the 3-point or more laser to the target through the laser rangefinder 120, moving the laser rangefinder 120 and the imaging unit 100 in the target direction T through the slide unit 130, and acquiring the 3-point or more laser irradiation points for each of the plurality of points.

In the present embodiment, the laser rangefinder 120 and the imaging unit 100 are moved in the direction of the target T, and the target T in the form of the grid paper is replaced each time the capturing is performed multiple times to mark three laser irradiation points, thereby acquiring the plurality of targets T on which the laser irradiation points are marked.

Step (ex-4) is a process of estimating an irradiation angle of the 3-point or more laser through a change in position for each of the 3-point or more laser irradiation points acquired in step (ex-3) and a movement distance of the laser rangefinder 120 and the imaging unit 110.

That is, when data on the change in the position for each of the 3-point or more laser irradiation points and the movement distance of the laser rangefinder 120 and the imaging unit 110 are acquired, yaws and pitches of each 3-point or more laser may be estimated.

In this way, the manufacturing error for the 3-point or more laser irradiated by the laser rangefinder 120 and the angle error that occurs when the laser rangefinder 120 is mounted on the imaging unit 110 may be compensated.

Thereafter, step (c) may be performed by reflecting the error degree measured in step (ex).

Specifically, the method of reflecting the error degree measured in step (ex) may be performed as follows.

The laser rangefinder 120 is configured such that the laser oscillation unit 122, which serves as the laser probe point, corresponds 1:1 to the distance calculation unit 123. In this case, the laser oscillation unit 122 and the distance calculation unit 123 corresponding to each other are provided at positions that are somewhat spaced apart from each other.

Therefore, first, a point where normal lines perpendicular to each distance calculation unit 123 of the laser rangefinder 120 intersect is set as an origin, and the laser irradiation points of each laser oscillation unit 122 are also set.

Each laser irradiation point may be expressed as in the following Equation 1.

$${C}_{t 0} = [ \begin{matrix}- offset & - {T}_{2} & {T}_{3} \\ {T}_{1} & - offset & offset \\ 0 & 0 & 0\end{matrix} ] \qquad [ Equation 1 ]$$

Tₙ: Distance from origin of laser rangefinder to center of distance calculation unit
Offset: Distance from center of distance calculation unit to center of laser oscillation unit

From the Equation 1, a rotation matrix may be generated using the angle of the laser estimated in the above-described step (ex). This may be expressed as in the following Equation 2.

$${R}_{n} ( {θ}_{t n} , {φ}_{tn} ) = [ \begin{matrix}cos {φ}_{t n} & 0 & sin {φ}_{tn} \\ sin {θ}_{t n} sin {φ}_{tn} & cos {θ}_{t n} & - sin {θ}_{tn} cos {φ}_{tn} \\ - cos {θ}_{tn} sin {φ}_{tn} & sin {θ}_{tn} & cos {θ}_{tn} cos {φ}_{tn}\end{matrix} ] \qquad [ Equation 2 ]$$

θₜₙ: Yaw angle of laser
φₜₙ: Pitch angle of laser

By multiplying the rotation matrix, the coordinates of the laser irradiation points of each laser oscillation unit, and the coordinates at an arbitrary distance D, the coordinates of each laser irradiation point may be generated. This may be expressed as in the following Equation 3.

$${P}_{n 0} = f ( 0 , {θ}_{tn} , {φ}_{tn} , {T}_{1} , {T}_{2} , {T}_{3} ) = R ( {θ}_{tn} , {φ}_{tn} ) {C}_{10} = R ( {θ}_{t n} , {φ}_{tn} ) [ \begin{matrix}- offset & - {T}_{2} & {T}_{3} \\ {T}_{1} & - offset & offset \\ 0 & 0 & 0\end{matrix} ] \qquad [ Equation 3 ]$$

$${P}_{nD} = f ( D , {θ}_{tn} , {φ}_{tn} , {T}_{1} , {T}_{2} , {T}_{3} ) = R ( {θ}_{tn} , {φ}_{tn} ) {C}_{1 D} = R ( {θ}_{t n} , {φ}_{tn} ) [ \begin{matrix}- offset & - {T}_{2} & {T}_{3} \\ {T}_{1} & - offset & offset \\ D & D & D\end{matrix} ]$$

P_{nO}: Coordinates of laser irradiation point at origin
P_{nD}: Coordinates of laser irradiation point at arbitrary distance

Thereafter, step (c) may be performed by reflecting the error degree based on the above Equation 3.

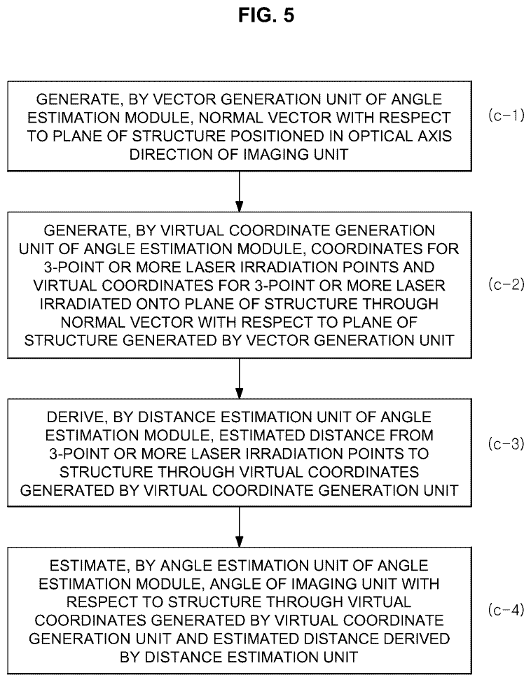

FIG. 5 is a diagram illustrating a detailed process of step (c) in the structure exterior inspection method according to an embodiment of the present invention.

As illustrated in FIG. 5, in the present embodiment, step (c) may include steps (c-1) to (c-4) in detail.

Step (c-1) is a process of generating, by the vector generation unit 210 of the angle estimation unit 200, the normal vector with respect to the plane of the structure positioned in the optical axis direction of the imaging unit 110.

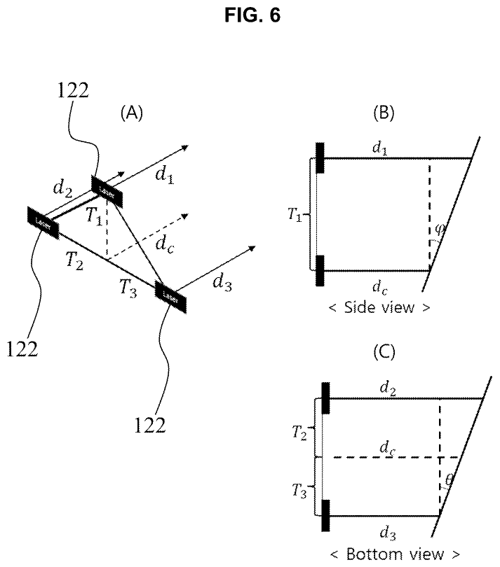

As illustrated in FIG. 6, this process calculates a normal vector using an arbitrary angle of a plane viewed by the imaging unit 110.

That is, when the structure of the laser rangefinder 120 is simplified as illustrated in FIG. 6A, the angle of the plane of the structure positioned in the optical axis direction of the imaging unit 110 illustrated in FIG. 6B with respect to the vertical line may be expressed as in the following Equation 4.

$$φ = arc tan ( \frac{{d}_{1} - {d}_{c}}{{T}_{1}} ) \qquad [ Equation 4 ]$$

In addition, the angle of the plane of the structure positioned in the optical axis direction of the imaging unit 110 illustrated in FIG. 6C with respect to the horizontal line may be expressed as in the following Equation 5.

$$θ = arc tan ( \frac{{d}_{2} - {d}_{3}}{{T}_{2} + {T}_{3}} ) \qquad [ Equation 5 ]$$

In this way, the normal vector for the plane of the structure positioned in the optical axis direction of the imaging unit 110 may be calculated using the angle of the primarily estimated plane of the structure. This may be expressed as in the following Equations 6 and 7.

$$nv = [ \begin{matrix}sin θ \\ cos θ sin φ \\ cos θ cos φ\end{matrix} ] \qquad [ Equation 6 ]$$

$$= \frac{nv}{‖ nv ‖} \qquad [ Equation 7 ]$$

nv: Normal vector
∥nv∥: Magnitude of normal vector
[symbol] : Normalized normal vector

Next, step (c-2) is a process of generating, by the virtual coordinate generation unit 220 of the angle estimation module 200, the coordinates for the 3-point or more laser irradiation points and the virtual coordinates for the 3-point or more laser irradiated onto the plane of the structure through the normal vector with respect to the plane of the structure generated by the vector generation unit 210.

This process may be performed through the following Equation 8.

$$\begin{matrix}{P}_{ne} = {P}_{nO} + \frac{- \cdot ( {P}_{n 0} - {O}_{p} )}{\cdot ( {P}_{nD} - {P}_{n 0} )} ( {P}_{nD} - {P}_{n 0} ) \\ {O}_{p} = [ \begin{matrix}0 & 0 & \overline{d} ]\end{matrix}\end{matrix} \qquad [ Equation 8 ]$$

Pₙₑ: Coordinates of virtual laser irradiation point on generated plane
P_{nO}: Origin coordinates of each laser irradiation point (D=0)
P_{nD}: Coordinates of each laser irradiation point at arbitrary distance (D>0)
Oₚ: Coordinates of one point on plane:
d̅: Average distance of measured three laser irradiation points

Step (c-3) is a process of deriving, by the distance estimation unit 230 of the angle estimation module 200, the estimated distance from the 3-point or more laser irradiation points to the structure through the virtual coordinates generated by the virtual coordinate generation unit 220.

This process may be performed by subtracting the coordinates of the origin of the laser irradiation points from the coordinates of the virtual laser irradiation points on the generated plane, which may be expressed as in the following Equation 9.

$${D}_{ne} = {P}_{ne} - {P}_{n 0} \qquad [ Equation 9 ]$$

Dₙₑ: Estimated distance from laser irradiation point to structure

The estimated distance derived in this way may be applied to the following Equation 10 so that the error from the actual measured distance is minimized.

$$Error = {min}_{R} {\sum }_{n = 1}^{3} ‖ {D}_{ne} - {D}_{nr} ‖ \qquad [ Equation 10 ]$$

Dₙᵣ: Actual distance of each laser

Step (c-4) is a process of estimating, by the angle estimation unit 240 of the angle estimation module 200, the angle of the imaging unit 110 with respect to the structure through the virtual coordinates generated by the virtual coordinate generation unit 220 and the estimated distance derived by the distance estimation unit 230.

Accordingly, the process of estimating, by the angle estimation module 200, the angle of the imaging unit 110 with respect to the plane of the structure that appears in the image captured by the imaging unit 110 to correct the error is completed.

Next, step (d) is a process of quantifying, by the quantification module 300, the damaged area of the structure appearing in the image captured by the imaging unit 110.

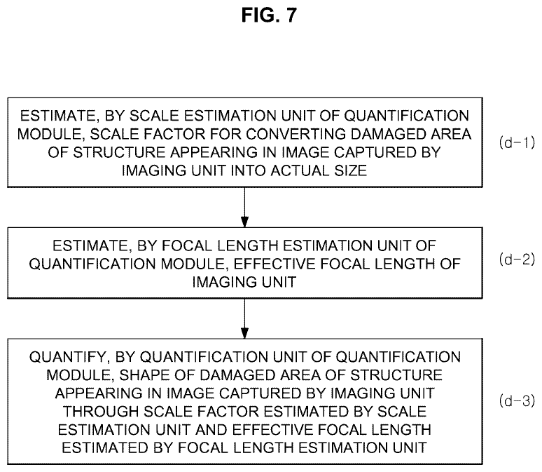

FIG. 7 is a diagram illustrating a detailed process of step (d) in the structure exterior inspection method according to an embodiment of the present invention.

As illustrated in FIG. 7, in the present embodiment, step (d) may include steps (d-1) to (d-3) in detail.

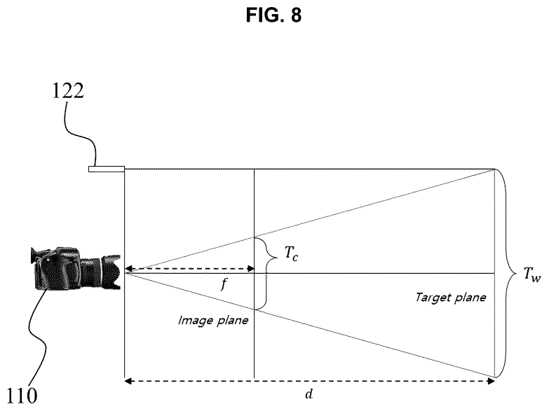

Step (d-1) is a process of estimating, by the scale estimation unit 310 of the quantification module 300, a scale factor (SF) for converting the damaged area of the structure appearing in the image captured by the imaging unit 110 into an actual size. As illustrated in FIG. 8, this process may be calculated by applying the following Equation 11 through the focal length of the imaging unit 110, the size of the damaged area of the structure in the coordinate system of the imaging unit 110, the size of the damaged area of the structure in the world (real) coordinate system, and the distance from the image sensor of the imaging unit 110 to the plane of the structure.

$$\begin{matrix}SF = \frac{d}{f} \\ {T}_{w} = {T}_{c} \times SF\end{matrix} \qquad [ Equation 11 ]$$

T_{w}: Target size at world coordinate system
T_{c}: Target size at camera coordinate system
f: Focal length
d: Distance from VID to target plane

However, a focus breathing phenomenon generally occurs in the imaging unit 110, and thus, the focal length may change continuously. Therefore, the estimation of the effective focal length based on the distance may be considered a method of more accurately calculating a scale factor.

This may be expressed as in the following Equation 12.

$$\begin{matrix}{SF}^{′} = \frac{d}{f} \\ {T}_{w} = {T}_{c} \times {SF}^{′}\end{matrix} \qquad [ Equation 12 ]$$

fₑ: Effective focal distance

Therefore, in step (d-2), the process of estimating, by the focal length estimation unit 320 of the quantification module 300, the effective focal length of the imaging unit 110 is performed.

This process may be derived through an inverse problem method using the currently known information, which is the size of the damaged area of the structure in the coordinate system of imaging unit 110, the size of the damaged area of the structure in the world (real) coordinate system, and the distance from the image sensor of the imaging unit 110 to the plane of the structure.

In other words, when the prior information of observing a shape whose target size in the world coordinate system is known from various distances is used, the effective focal length may be accurately estimated.

Step (d-3) is a process of quantifying, by the quantification unit 330 of the quantification module 300, the damaged area shape of the structure that appears in the image captured by the imaging unit 110 using the scale factor estimated by the scale estimation unit 310 and the effective focal length estimated by the focal length estimation unit 320.

In this way, the process of quantifying, by the quantification module 300, the damaged area of the structure appearing in the image captured by the imaging unit 110 is completed.

Next, step (e) is the process of reading, by the damage reading module 400, the damage status of the structure appearing in the image captured by the imaging unit 110.

In this step (e), the damage reading module 400 may provide one or more software provided in a form recorded on a storage medium readable by a computing device.

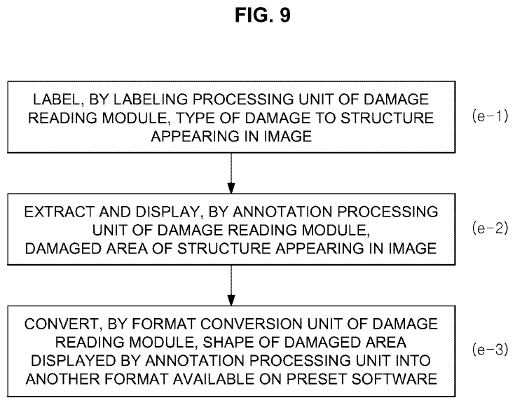

FIG. 9 is a diagram illustrating a detailed process of step (e) in the structure exterior inspection method according to an embodiment of the present invention.

As illustrated in FIG. 9, in the present embodiment, step (e) may include steps (e-1) to (e-3) in detail.

Step (e-1) is the process of labeling, by the labeling processing unit 410 of the damage reading module 400, the type of damage of the structure appearing in the image.

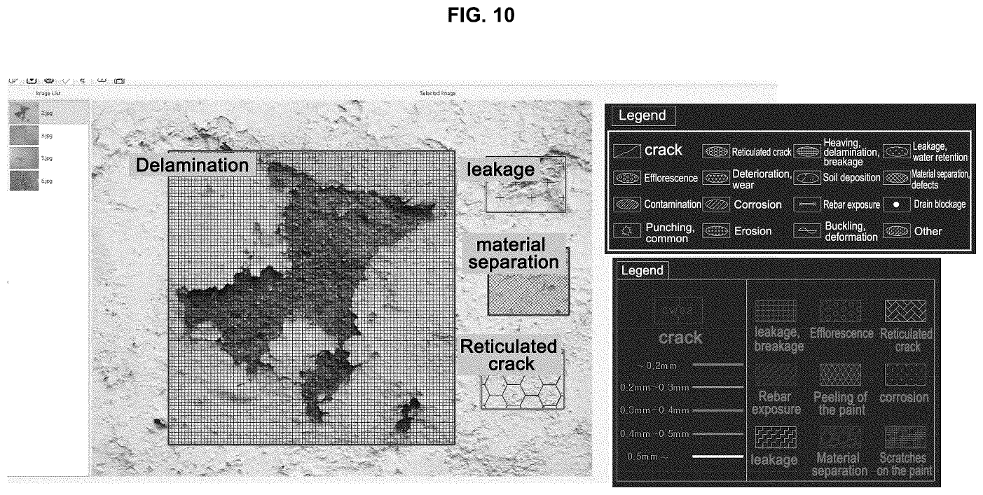

As illustrated in FIG. 10, the process may be performed by a method of labeling the type of damage to the structure through one or more software provided in a form recorded on a storage medium readable by a computing device.

In this case, the process may be a method that is performed manually by an operator directly utilizing software, or performed automatically through an artificial intelligence-based deep learning network learning process.

In addition, the software may provide various damage lists, and it is possible to display patterns according to predefined damage. For example, legends of two types of exterior inspection network diagrams are exemplified in FIG. 10, and a pattern may be displayed according to one of the legends.

Step (e-2) is a process of extracting and displaying, by the annotation processing unit 420 of the damage reading module 400, the damaged area of the structure appearing in the image.

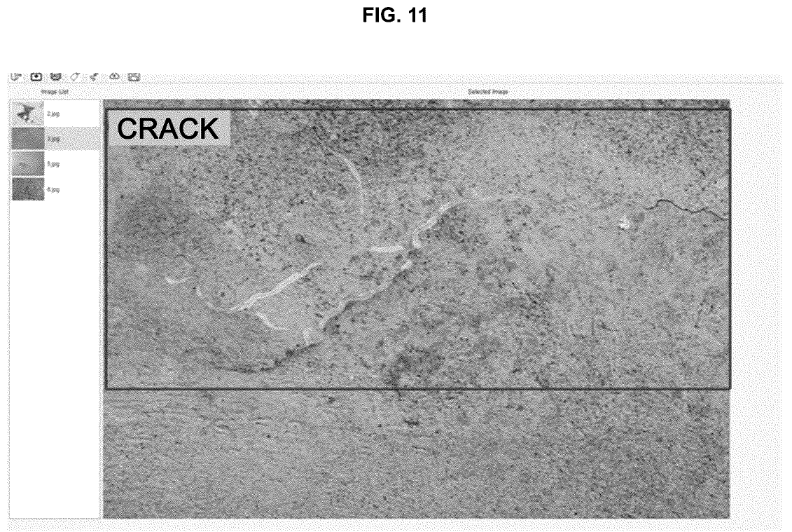

Similarly, as illustrated in FIG. 11, the process may also be performed by a method of extracting the damaged area of the structure through one or more software provided in the form recorded on the storage medium readable by the computing device.

The process may also be either a method of an operator manually marking an annotation using software directly or a method of automatically performing an annotation through an artificial intelligence-based deep learning network learning process.

In addition, when the annotation is automatically performed through the artificial intelligence-based deep learning network learning process, it is also possible for the operation to additionally display the annotation.

Meanwhile, in this process, the quantification unit 330 of the quantification module 300 described above may quantify the labeled and annotated damage on the software.

In particular, when the type of damage is not a crack, the quantification module 300 described above may automatically calculate the area of the labeled box in step (e-1), and the quantification module 300 also calculates an area of a calculated box as the amount of damage to be repaired.

This may also be calculated based on the angle of the imaging unit 110 derived by the angle estimation module 200 and the scale factor derived by the quantification module 300.

Thereafter, the quantification module 300 may display the calculated amount of damage to be repaired on the software.

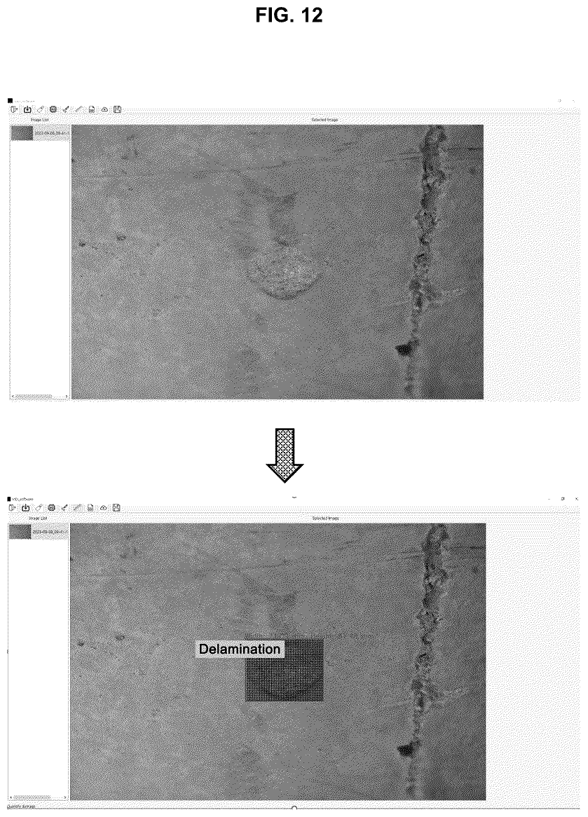

FIG. 12 illustrates an example of automatically calculating the area of the labeled box in software and displaying the calculated area on the screen.

In this example, the area of the labeled box is estimated to be 71 mm*81 mm for damage with an actual size of 70 mm*80 mm, which may be confirmed that this is almost the same result within the error range.

In addition, when the type of damage is a crack, the quantification unit 330 of the quantification module 300 described above may automatically calculate the length of the annotated part in step (e-2), and a width of the crack may be automatically calculated by an operator activating a pre-built ruler function in the software and performing and selecting an operation such as dragging using an input device.

Thereafter, the quantification module 300 may display the calculated length and width of the crack on the software.

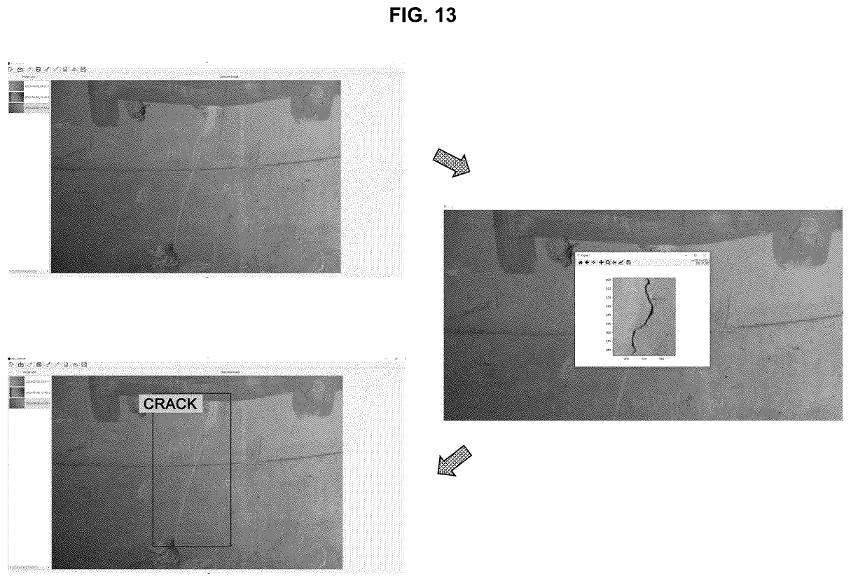

FIG. 13 illustrates an example of automatically calculating the length and width of the annotated crack on the software and displaying the calculated length and width of the annotated crack on the screen.

In this example, the length of the annotated crack is estimated to be 527.72 and the width of the annotated crack is estimated to be 0.15 mm for a crack with an actual length of 500 mm and a width of 0.15 mm, which may be confirmed that this is almost the same result within the error range.

Step (e-3) is a process of converting, by the format conversion unit 430 of the damage reading module 400, into the form of the damaged area indicated by the annotation processing unit 420 into another format that is available on the preset software.

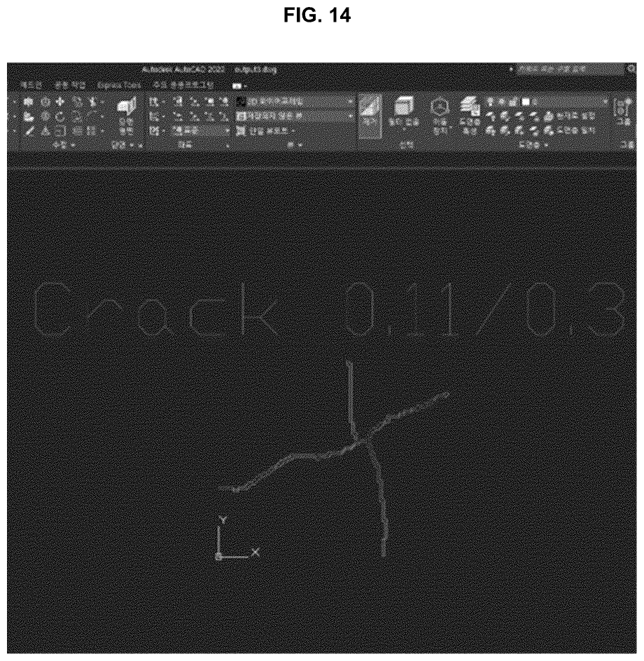

As illustrated in FIG. 14, this process may be used by converting the form of the annotated damaged area into a format that can be used by external software, such as CAD software, through one or more software provided in the form recorded on the storage medium readable by the computing device.

Meanwhile, all data generated during each of the above procedures may be built into a scalable database by utilizing NoSQL-based DynamoDB and a S3 bucket capable of high-capacity storage.

In addition, the present invention may build a system that strengthens an artificial intelligence-based damage determination function through data uploaded to a database, and build a growth platform through continuous strengthening later.

The preferred embodiment of the present invention has been described hereinabove, and it is obvious to those skilled in the art that the present invention may be embodied in other specific forms without departing from the spirit or scope of the present invention, in addition to the above-described embodiment. Therefore, the above-described embodiment is to be regarded as being illustrative rather than being restrictive, and accordingly, the present invention is not limited to the above description, but may be modified within the scope of the claims and their equivalents.

1. A structure exterior inspection system, comprising:
an image capturing unit including an imaging unit that captures an exterior image of a structure and a laser rangefinder that irradiates a 3-point or more laser to a surface of the structure within a field of view of the imaging unit;
an angle estimation module estimating an angle of the imaging unit with respect to a plane of the structure appearing in the image captured by the imaging unit;
a quantification module quantifying a damaged area of the structure appearing in the image captured by the imaging unit; and
a damage reading module reading a damage status of the structure appearing in the image captured by the imaging unit.

2. The structure exterior inspection system of claim 1, wherein the laser rangefinder is arranged to maintain a uniform relative position with respect to the imaging unit.

3. The structure exterior inspection system of claim 2, wherein the laser rangefinder is formed in a form that it is mounted on the imaging unit.

4. The structure exterior inspection system of claim 3, wherein the laser rangefinder includes:
a body including a connecting part arranged to be mounted on the imaging unit;
3 or more laser oscillation units mounted on the body and irradiating laser; and
a distance calculation unit calculating a distance from a laser irradiation point of the laser oscillation unit to the structure.

5. The structure exterior inspection system of claim 1, wherein the angle estimation module includes:
a vector generation unit generating a normal vector with respect to the plane of the structure positioned in an optical axis direction of the imaging unit;
a virtual coordinate generation unit generating coordinates for the 3-point or more laser irradiation points and virtual coordinates for the 3-point or more laser irradiated to the plane of the structure through the normal vector with respect to the plane of the structure generated by the vector generation unit;
a distance estimation unit deriving an estimated distance from the 3-point or more laser irradiation points to the structure through the virtual coordinates generated by the virtual coordinate generation unit; and
an angle estimation unit estimating an angle of the imaging unit with respect to the structure through the virtual coordinates generated by the virtual coordinate generation unit and the estimated distance derived by the distance estimation unit.

6. The structure exterior inspection system of claim 1, wherein the quantification module includes:
a scale estimation unit estimating a scale factor for converting a damaged area of the structure appearing in the image captured by the imaging unit into an actual size;
a focal length estimation unit estimating an effective focal length of the imaging unit; and
a quantification unit quantifying a shape of the damaged area of the structure appearing in the image captured by the imaging unit through the scale factor estimated by the scale estimation unit and the effective focal length estimated by the focal length estimation unit.

7. The structure exterior inspection system of claim 1, wherein the damage reading module includes:
a labeling processing unit labeling a type of damage of the structure appearing in the image;
an annotation processing unit extracting and displaying the damaged area of the structure appearing in the image; and
a format conversion unit converting the shape of the damaged area displayed by the annotation processing unit into another format available on preset software.

8. A structure exterior inspection method, comprising:
(a) irradiating a surface of a structure with a 3-point or more laser through a laser rangefinder;
(b) capturing an exterior image of the structure through an imaging unit;
(c) estimating, by an angle estimation module, an angle of the imaging unit with respect to a plane of the structure appearing in the image captured by the imaging unit to correct an error;
(d) quantifying, by a quantification module, a damaged area of the structure appearing in the image captured by the imaging unit; and
(e) reading, by a damage reading module, a damage status of the structure appearing in the image captured by the imaging unit.

9. The structure exterior inspection method of claim 8, wherein the laser rangefinder is arranged to maintain a uniform relative position with respect to the imaging unit, and
the steps (a) and (b) are performed multiple times by varying a distance between the imaging unit and the laser rangefinder and the structure to acquire a plurality of images.

10. The structure exterior inspection method of claim 8, wherein the step (c) includes:
(c-1) generating, by a vector generation unit of the angle estimation unit, a normal vector with respect to the plane of the structure positioned in an optical axis direction of the imaging unit;
(c-2) generating, by a virtual coordinate generation unit of the angle estimation module, coordinates for 3-point or more laser irradiation points and virtual coordinates for the 3-point or more laser irradiated to the plane of the structure through the normal vector with respect to the plane of the structure generated by the vector generation unit;
(c-3) deriving, by a distance estimation unit of the angle estimation module, an estimated distance from the 3-point or more laser irradiation points to the structure through the virtual coordinates generated by the virtual coordinate generation unit; and
(c-4) estimating, by an angle estimation unit of the angle estimation module, an angle of the imaging unit with respect to the structure through the virtual coordinates generated by the virtual coordinate generation unit and the estimated distance derived by the distance estimation unit.

11. The structure exterior inspection method of claim 8, further comprising:
prior to the step (c), (ex) measuring an error degree for the 3-point or more laser irradiated by the laser rangefinder,
wherein the step (c) is performed by reflecting the error degree measured in the step (ex).

12. The structure exterior inspection method of claim 11, wherein the step (ex) includes:
(ex-1) positioning a target in front of a slide unit provided so that the mounting target is movable back and forth along a straight track;
(ex-2) mounting the laser rangefinder and the imaging unit provided so as to maintain a uniform relative position to each other on the slide unit;
(ex-3) irradiating the 3-point or more laser onto the target through the laser rangefinder, moving the laser rangefinder and the imaging unit in the target direction through the slide unit, and acquiring the 3-point or more laser irradiation points for each of a plurality of points; and
(ex-4) estimating an irradiation angle of the 3-point or more laser through a change in position for each of the 3-point or more laser irradiation points acquired in the step (ex-3) and a movement distance of the laser rangefinder and the imaging unit.

13. The structure exterior inspection method of claim 8, wherein the step (d) includes:
(d-1) estimating, by a scale estimation unit of the quantification module, a scale factor for converting a damaged area of the structure appearing in the image captured by the imaging unit into an actual size;
(d-2) estimating by a focal length estimation unit of the quantification module, an effective focal length of the imaging unit; and
(d-3) quantifying, by a quantification unit of the quantification module, a shape of the damaged area of the structure appearing in the image captured by the imaging unit through the scale factor estimated by the scale estimation unit and the effective focal length estimated by the focal length estimation unit.

14. The structure exterior inspection method of claim 8, wherein the step (e) includes:
(e-1) labeling, by a labeling processing unit of the damage reading module, a type of damage to the structure appearing in the image;
(e-2) extracting and displaying, by an annotation processing unit of the damage reading module, the damaged area of the structure appearing in the image; and
(e-3) converting, by a format conversion unit of the damage reading module, a shape of the damaged area displayed by the annotation processing unit into another format available on preset software.
